(19) United States
(12) Patent Application Publication
(10) Pub. No.: US 2004/0252721 A1
(43) Pub. Date: Dec. 16, 2004

(54) Bundled internet protocol packets

(75) Inventors: Charles Steven Lingafelt, Durham, NC (US); Phuong Thanh Nguyen, Cary, NC (US)

Correspondence Address: IBM CORPORATION - PERSONAL SYSTEMS GROUP, Intellectual Property Law, Dept. 9CCA/002/2, 3039 Cornwallis Road, P.O. Box 12195, Research Triangle Park, NC, 27709, US

(73) Assignee: International Business Machines Corporation, Armonk, NY

(21) Appl. No.: 10/462,257

(22) Filed: Jun. 16, 2003

(51) Int. Cl. H04L 12/56

(52) U.S. Cl. 370/473

(57) ABSTRACT

A system and method in which network packets sharing a common destination are bundled into one or more larger packets. In one embodiment, an originating server, gateway, or other network device recognizes the presence of multiple, small IP packets having a common IP address. The network device according to the present invention is configured to concatenate or bundle two or more such small packets. The bundled packet as a whole is then given a new header, the bundle header, that includes the network destination address and information that informs the receiving protocol processing device that the packet is a bundled packet. The receiving device can then strip off the bundle header and process the component packets individually according to an existing protocol.

### BACKGROUND

1. Field of the Present Invention

The present invention generally relates to the field of data processing networks and more particularly to protocols for transmitting network packets between network addresses.

2. History of Related Art

Information networks including the Internet are typically designed to transmit information in discrete units referred to as packets. Each packet must be processed according to a specific protocol or set of protocols as it traverses the network from its origin or source to its destination. Although network packets can vary widely in size, there is empirical evidence suggesting that the majority of packets flowing through large networks such as the Internet at any give point in time are relatively small.

Requiring the same amount of protocol processing as very large packets, small packets can quickly saturate a network's ability to process them. Network servers, routers, and other devices handling a large volume of small packets must devote an undesirably excessive amount of their resources to overhead processing. It would, therefore, be desirable to implement a network mechanism that addressed this characteristic of packetized networks and attempted to reduce the amount of processing overhead required to handle the packets. It would be further desirable if the implemented solution built upon and did not require any significant modifications to existing network protocols.

### SUMMARY OF THE INVENTION

A system and method in which small packets having a common destination are bundled into one or more larger packets to address the problem described above. In one embodiment, an originating server, gateway, or other network device recognizes the presence of multiple, small IP packets having a common IP address. The network device according to the present invention is configured to concatenate or bundle two or more such small packets. The bundled packet as a whole is then given a new header, the bundle header, that includes the network destination address and information that informs the receiving protocol processing device that the packet is a bundled packet. The receiving device can then strip off the bundle header and process the component packets individually according to an existing protocol. In one embodiment, protocol processing is reduced by determining a check sum or other error correction information for the bundle as a whole. If the receiving device determines that the bundle passes the error checking routine, the individual packets are assumed to have also passed thereby enabling reduced error checking. The bundled header may be indicated by using a unique IP protocol number in the bundle header, using a unique port number in the header, or some other technique requiring little or no fundamental changes to the header structure.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a data processing network emphasizing the distribution of network packets to a common destination address;

FIG. 2A and FIG. 2B are conceptual representations of a group of small packets, and their corresponding bundled packet according to an embodiment of the present invention;

FIG. 3 is a flow diagram of a method of distributing and receiving information over a data processing network according to one embodiment of the present invention;

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the invention pertains to the distribution of packets over a network and more particularly to distributing a large number of relatively small packets over the network. A network device such as a server or router buffers multiple packets and determines that two or more of the buffered packets have a common destination address. The device forms a larger packet, referred to herein as a bundled packet, that includes the smaller packets as well as a header that applies to the bundled packet as a whole. Because the bundled packet includes only those packets having a common destination address, the bundled packet represents less processing overhead to the network devices responsible for routing and otherwise processing the packets. To minimize the impact on existing protocol processing mechanisms, the bundled packet process is preferably implemented in a manner that does not alter the structure of the individual packets.

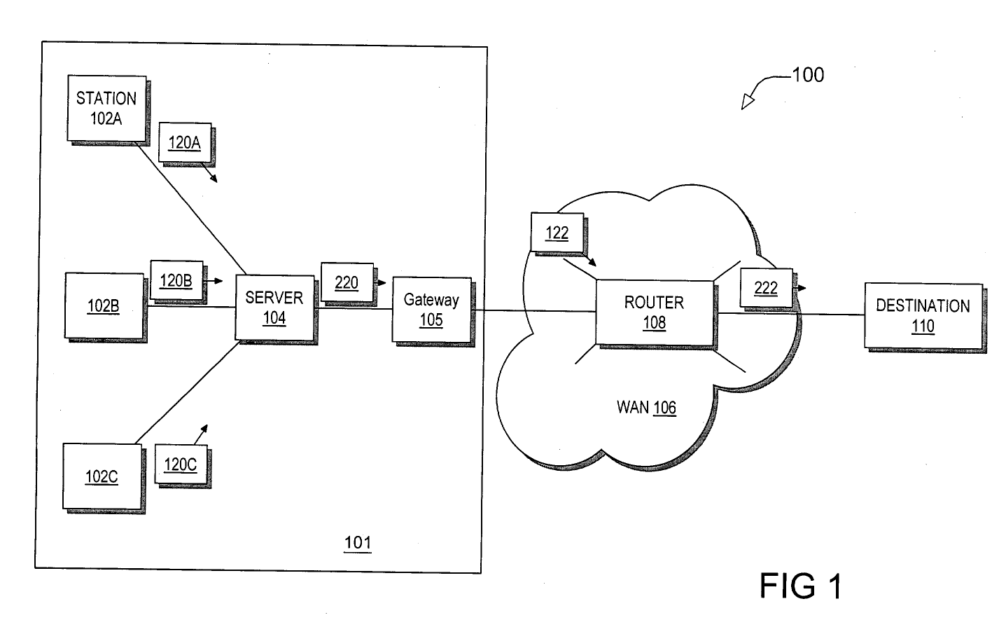

Turning now to the drawings, FIG. 1 depicts selected elements of a data processing network 100 emphasizing one implementation of the present invention. In the depicted embodiment, data processing network 100 includes a network site or location 101 connected to a wide area network 106. Network location 101 as depicted in FIG. 1 includes a set of network stations, three of which are represented by reference numeral 102A through 102C (generically or collectively referred to as network station(s) 102).

Network stations 102 represent sources of network packets. As depicted, each network station 102A through 102C generates network packets 120A through 120C, respectively. Network stations 102 may, for example, represent a collection of email or web browser clients within a corporation network, a set of telnet servers connected within a university or other organization, a set of users subscribing to a common internet service provider, and so forth.

The packets generated by network stations 102A through 102C as depicted in FIG. 1 pass through a common server 104 that connects network destination 101 to wide area network 106 through an intervening gateway 105. From the perspective of wide area network 106, all of the elements incorporated within network location 101 represent a single network entity or single network address. Server 104 receives packets from a potentially large number of network stations 102. As packets are received, server 104 may buffer them prior to forwarding them to wide area network 106 for delivery to their ultimate destination. In many cases, each individual network packet 120 occupies a unique buffer of server 104. If the applications represented by network stations 102 are generating a large number of packets, the server's buffers may quickly become saturated.

Network server 104 as depicted in FIG. 1 is preferably configured to address this potential problem by incorporating a protocol processing extension referred to herein as bundle processing. Server 104 is arranged to monitor for the presence of multiple network packets 120 having a common destination network address. Typically, every network packet includes network address information indicating the desired destination of the packet. In an embodiment of network 100 that employs the most widely implemented network protocol, network packets 120 are compliant with the Internet Protocol (IP) specified in Internet Engineering Task Force Standard (IETF) Standard No. 5, RFC 791. The Internet Protocol is a low level protocol that specifies the manner in which a packet indicates its network source address and its destination address.

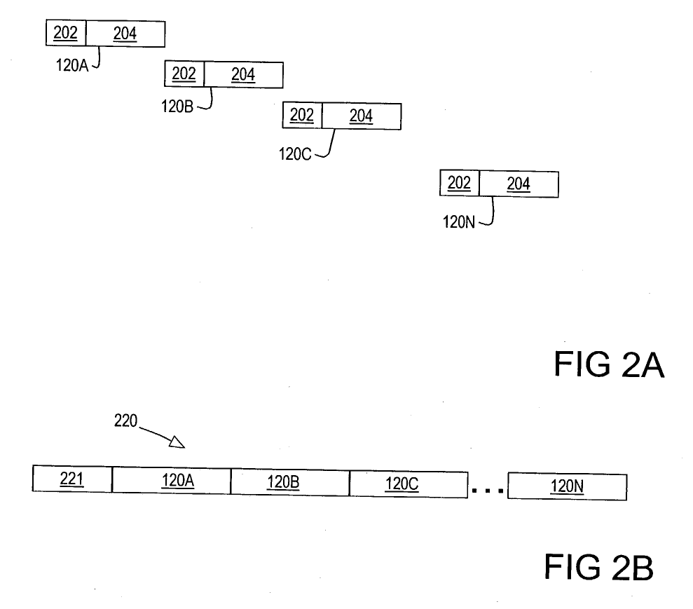

Referring to FIG. 2A, a set of individual network packets 120A through 120N (generically or collectively identified as network packet(s) 120) generated by the network stations 102 of FIG. 1 are depicted. Network packets 120 may be generated by a single network station 102 or by two or more of the network stations. More generally, as described below, packets 120 need not necessarily have a common source network address. As depicted in FIG. 2A, each network packet 120 includes a corresponding header 202 and data portion 204. The header portion 202 represents a network layer protocol header such as an IP compliant header as specified in RFC 791. The data portion 204 of each packet 120 represents the packet's “payload” and may include headers and data portions of higher level protocols.

The network protocol extension contemplated by the present invention acts on multiple network packets that share a common destination network address. In an IP implementation, for example, the header portion 202 of packets 120 represents an IP header that includes a 32-bit source network address and a 32-bit destination network address. To illustrate the benefits of the invention, each network packet 120 depicted in FIG. 2A shares a common destination address.

Momentarily referring back to FIG. 1, network packets 120 generated by network stations 102 are routed to wide area network 106 through a server 104 and gateway 105. Server 104 according to the present invention is enabled to process network packets 120 into a network bundle represented by reference numeral 220 of FIG. 2B. Network bundle 220 includes a bundle header 221 and a collection of individual network packets 120A through 120N that share a common destination address. In the preferred embodiment, the network packets 120 that share a common destination address are incorporated into the bundle packet substantially without alteration. In other words, the bundle processing required to form bundle packet 220 preferably does not modify the individual network packets 120 from their original form. Maintaining the original form of the packets 120 facilitates the integration of bundle processing into existing protocol processing stacks. With the original packets 120 included within the bundled packet 220, the bundle processing required at the destination is relatively simple. More specifically, the bundle protocol processing at the destination includes determining that the packet is a bundle packet and then unbundling the individual packets 120 for delivery to the next layer in the destination server's protocol stack.

By bundling packets sharing a common destination network address, server 104 conserves the number of buffers required to temporarily store the packets. If, for example, a network server incorporates a limited amount of buffer space for outbound packets and the individual packets 120 are small, numerous, and destined for a common network address, bundling of individual packets can reduce the number of buffer entries required to hold the outbound packets and thereby increase the availability of buffer space for other packets. In addition to reducing buffering requirements, the bundling of network packets 120 can beneficially improve the overall throughput of network 100 by decreasing the amount of packet processing that occurs in transit between the source network address and the destination network address.

The reduced network processing benefit of the present invention is conceptually represented by the router 108 in FIG. 1. Router 108 receives network packets from various source network addresses including network destination 101. In the absence of bundled packets as describe herein, router 108 must perform routing processing on each individual network packet that it receives. As indicated previously, empirical studies suggest that the “average” packet size is relatively small (i.e., less than 1 KB). Moreover, there are many applications in which a large number of small packets shared a common destination network address. Under these conditions, it will be appreciated that network server 108 is required to spend a great deal of processing time routing small packets to the same or a few frequently occurring network addresses.

According to one embodiment, network router 108 is enabled with bundle protocol processing substantially similar in function to the bundle protocol processing described above with respect to server 104. Router 108 is preferably configured with the ability to form network bundles from individual network packets, previously bundled network packets, or a combination of the two. As depicted in FIG. 1, router 108 receives a network bundle 220 from network destination 101 and an individual packet from a different source, identified by reference numeral 122. Packets 220 and 122 share a common network destination. Router 108 is preferably configured to buffer incoming network bundle 220 and individual packet 122. Upon recognizing that the two buffered items share a common destination, router 108 is enabled to deconstruct network bundle 220 into its individual bundles 120 and to form an even larger network bundle by incorporating the network packet 122 into the new bundle 222. Ultimately, after traversing any intermediate network devices between router 108 and destination 110, bundled network packet 222 is delivered to the network destination 110 as a large bundle.

Network destination 110 represents a server, likely a server having a popular internet address such as a popular web portal, telnet site, chat room, and so forth. Network destination 110 may include one or more local area networks behind a firewall or gateway (not depicted). Upon receiving a network packet, destination 110 begins its protocol processing. According to the present invention, destination 110 first determines that packet 222 is a bundled packet. Destination 110 then strips off the bundle header that was previously attached to the bundled packet by router 108 or some other network device.

One source of increased efficiency made possible by the bundle processing is the check sum processing that is commonly performed on network packets to insure that there are no bit failures in the packet data. Theoretical processing of bundled packets may opt to bypass the checksum processing for the individual network packets. Instead, the server 104, router 108, or any other network device that is capable of determining a checksum can compute a bundle checksum and include the bundle checksum as part of the bundle header 221. Destination 110 may then elect to verify the bundle checksum and, if it passes, forward the entire bundle into post checksum processing. In this manner, the present invention improves network efficiency by reducing or minimizing the amount of network processing that must be performed to route large numbers of small packets successfully.

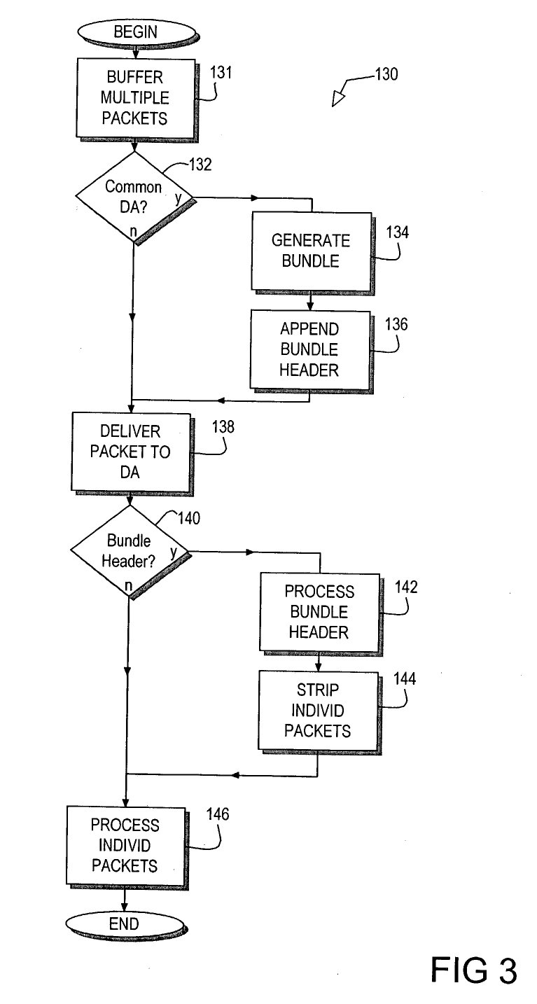

Portions of the protocol processing are implemented as a set of computer executable instructions (software) stored on a computer readable medium. In this embodiment, the executable instructions, when executed by a data processing system, may perform the bundle protocol construction and deconstruction. FIG. 3 is a flow diagram illustrating a conceptualized representation of bundle network processing according to the present invention. In the depicted embodiment, a method 130 of implementing bundled packet processing according to an embodiment of the present invention includes buffering (block 131) multiple packets that share a common destination IP address. This buffering is necessary to form a collection of network packets that may be bundled. The buffering of these packets may occur on virtually any network device, but preferably occurs at least in the server 104 of FIG. 1 and the intermediate router 108 of wide area network 106.

The bundle packet protocol processing includes determining (block 132) whether two or more of the buffered packets share a common destination address. If multiple such individual packets exist, the bundle processing then includes generating (block 134) the data portion of the bundled packet by concatenating all of the individual network packets that have the common destination address. Although described with respect to server 104, the location where bundle processing occurs is implementation specific and all such implementation lie within the scope of the present invention. Upon completing the formation of the bundle, a bundle header is appended (block 136) to the bundle packet. The bundle header will include of course the (single) destination network address for all of the individual packets that make up the bundle.

Once the bundle packet is completed, it is then forwarded on to its network address in block 138. At the destination or receiving end of the network, a server for processing incoming packets is employed. The receiving server initially determines whether a received packet is a bundle packet. The indication of a bundle packet may be achieved in different ways. In one embodiment, a unique protocol number is assigned for bundle processing and this protocol number is stored in the next level protocol field of the standard IP header. In another embodiment, the bundle header may indicate a secondary protocol such as TCP or UDP that incorporates ports into their respective header formats. In this embodiment, the bundle processing may be achieved by specifying a unique and dedicated port number for bundle processing. Upon detecting a bundle header in block 140, the destination server then deconstructs the network bundle by first performing any remaining processing associated with the bundle. The bundle header is identified and processed (block 142) and the individual packets are then stripped out (block 144) and forwarded to the remainder of the protocol stack for processing (block 146) of individual packets.

It will be apparent to those skilled in the art having the benefit of this disclosure that the present invention contemplates a system and method for bundling network packets into more efficiently processed packets. It is understood that the form of the invention shown and described in the detailed description and the drawings are to be taken merely as presently preferred examples. It is intended that the following claims be interpreted broadly to embrace all the variations of the preferred embodiments disclosed

What is claimed is:

1. A method of processing packets in a data processing network, comprising:
responsive to determining that a plurality of packets share a common destination address, creating a bundle packet comprising the plurality of packets and a bundle header;
transmitting the bundle packet as a single packet via the network to the destination address; and
responsive to the destination address receiving the bundle packet, processing the bundle packet header, stripping the plurality of packets from the bundle packet, and processing the stripped packets.

2. The method of claim 1, wherein determining that a plurality of packets share a common destination address is further characterized as determining that a plurality of packets share a common destination IP address.

3. The method of claim 1, wherein creating the bundle packet includes concatenating the plurality of packets to the bundle header wherein each of the plurality of packets is retained in its original form within the bundle packet.

4. The method of claim 1, wherein processing the bundle header includes recognizing the packet as a bundle packet by decoding a predetermined protocol number in a protocol field of the bundle header.

5. The method of claim 1, wherein processing the bundle header includes recognizing the packet as a bundle packet by decoding a predetermined port number in the header of the packet.

6. The method of claim 1, wherein creating a bundle packet includes generating a checksum for the bundle packet and including the checksum in the bundle packet header.

7. The method of claim 6, wherein processing the bundle packet header includes verifying the bundle header checksum such that checksum processing of the plurality of packets is rendered unnecessary.

8. A data processing network comprising:
a network device including a plurality of buffers for queuing packets to be sent over the network;
protocol processing means for recognizing a plurality of packets stored in the buffers as having a common destination address;
protocol processing means for generating a bundle packet from the plurality of packets, wherein the bundle packet includes a bundle header and each of the plurality of packets; and
network means for transmitting the bundle packet to the network.

9. The network of claim 8, wherein the network device is further characterized as a router.

10. The network of claim 9, wherein at least one of the packets in the buffers is a previous bundle packet and wherein the means for generating the bundle packet includes means for stripping individual packets from the previous bundle packet and incorporating the stripped packets into the generated bundle packet.

11. The network of claim 8, wherein the processing means for generating a bundle packet includes means for concatenating the plurality of packets to the bundle header wherein each of the plurality of packets is retained in its original form within the bundle packet.

12. The network of claim 8, further comprising a network device for receiving the bundle packet from the network and means for recognizing the packet as a bundle packet by decoding a predetermined protocol number in a protocol field of the bundle header.

13. The network of claim 8, further comprising a network device for receiving the bundle header from the network and means for recognizing the packet as a bundle packet by decoding a predetermined port number in a header of the packet.

14. The network of claim 8, wherein the means for generating a bundle packet includes means for generating a checksum for the bundle packet and including the checksum in the bundle packet header.

15. The network of claim 14, further comprising means for processing the bundle packet header including means for verifying the bundle header checksum wherein checksum processing of the plurality of packets within the bundle packet is avoided.

16. A computer program product for processing packets in a data processing network, the product being stored on a computer readable medium, comprising:
responsive to determining that a plurality of packets share a common destination address, code means for creating a bundle packet comprising the plurality of packets and a bundle header;
code means for transmitting the bundle packet as a single packet via the network to the destination address; and
responsive to the destination address receiving the bundle packet, code means for processing the bundle packet header, stripping the plurality of packets from the bundle packet, and processing the stripped packets.

17. The computer program product of claim 16, wherein code means for determining that a plurality of packets share a common destination address is further characterized as determining that a plurality of packets share a common destination IP address.

18. The computer program product of claim 16, wherein the code means for processing the plurality of packets includes code means for concatenating the plurality of packets wherein each of the packets is retained in its original form within the bundle packet.

19. The computer program product of claim 16, wherein the code means for processing the bundle header includes code means for recognizing the packet as a bundle packet by decoding a predetermined protocol number in a next level protocol field of the bundle header.

20. The computer program product of claim 16, wherein the code means for processing the bundle header includes code means for recognizing the packet as a bundle packet by decoding a predetermined port number in a TCP or UDP header of the packet.

21. The computer program product of claim 16, wherein the code means for creating a bundle packet includes code means for generating a checksum for the bundle packet and including the checksum in the bundle packet header.

22. The computer program product of claim 21, wherein the code means for processing the bundle packet header includes code means for verifying the bundle header checksum.
